(19) United States
(12) Patent Application Publication
(10) Pub. No.: US 2014/0041211 A1
(43) Pub. Date: Feb. 13, 2014

(54) METHODS FOR FABRICATING LITHIUM BATTERY ANODES

(71) Applicants: TSINGHUA UNIVERSITY, Beijing (CN); HON HAI PRECISION INDUSTRY CO., LTD., New Taipei (TW)

(72) Inventors: XING-FENG HE, Beijing (CN); YANG WU, Beijing (CN); JIA-PING WANG, Beijing (CN); KAI-LI JIANG, Beijing (CN); SHOU-SHAN FAN, Beijing (CN)

(73) Assignees: HON HAI PRECISION INDUSTRY CO., LTD., New Taipei (TW); Tsinghua University, Beijing (CN)

(21) Appl. No.: 13/869,962

(22) Filed: Apr. 25, 2013

(30) Foreign Application Priority Data
Aug. 13, 2012 (CN) 2012102860732

(51) Int. Cl. H01M 4/04

(52) U.S. Cl. CPC H01M 4/0402
USPC 29/623.5; 427/113

(57) ABSTRACT

A method for fabricating a lithium battery anode is related. A carbon nanotube film structure and an anode active solution are provided. The anode active solution is obtained by mixing an organic solvent with an Co(NO₃)₂ solution. The anode active solution is sprayed on the carbon nanotube film structure to form a pre-anode. The pre-anode is heated.

### CROSS-REFERENCE TO RELATED APPLICATIONS

This application claims all benefits accruing under 35 U.S.C. §119 from China Patent Application No. 201210286073.2, filed on Aug. 13, 2012 in the China Intellectual Property Office, the disclosure of which is incorporated herein by reference. This application is related to applications entitled, “METHOD FOR FABRICATING LITHIUM BATTERY ANODES”, filed **** (Atty. Docket No. US45587).

### BACKGROUND

1. Technical Field

The present invention relates to methods for fabricating lithium battery anodes.

2. Discussion of Related Art

In recent years, lithium batteries have received a great deal of attention. Lithium batteries are used in various portable devices, such as notebook PCs, mobile phones, and digital cameras, because of their small weight, high discharge voltage, long cyclic life, and high energy density.

A conventional method for making a lithium battery anode includes steps of: providing an anode active material, a number of conductive particles and a binder; mixing the anode active material, the conductive particles and the binder together to form a slurry; shaping and baking the slurry to form the lithium battery anode. However, the conductive particles are prone to aggregation, as such, the performance of the lithium battery anode will be decreased.

What is needed, therefore, is to provide a method for making a lithium battery anode, which can overcome the above-described shortcomings.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 shows a flowchart of one embodiment of a method for fabricating a lithium battery anode.

FIG. 2 is a scanning electron microscope (SEM) image of a drawn carbon nanotube film.

FIG. 3 is an SEM image of a pressed carbon nanotube film.

FIG. 4 is an SEM image of a flocculated carbon nanotube film.

FIG. 5 is an SEM image of one embodiment of a lithium battery anode.

FIG. 6 shows a flowchart of another embodiment of a method for fabricating a lithium battery anode.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

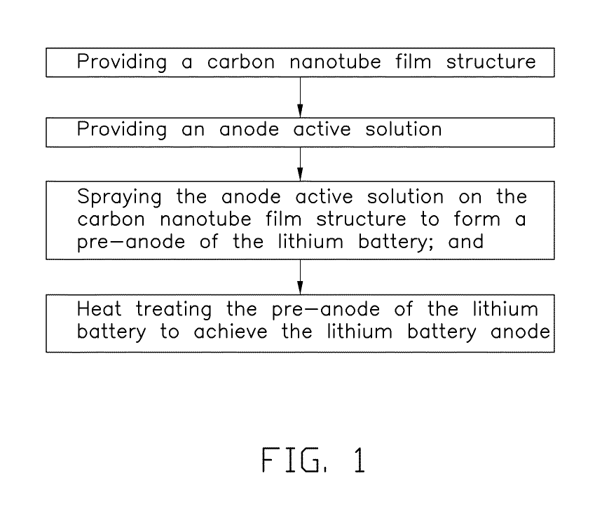

Referring to FIG. 1, an embodiment of a method for fabricating a lithium battery anode of one embodiment includes the steps of: (S10) providing a carbon nanotube film structure; (S11) providing an anode active solution; (S12) spraying the anode active solution on the carbon nanotube film structure to form a pre-anode; and (S13) heat treating the pre-anode.

In step (S10), the carbon nanotube film structure can be a free-standing structure, that is, the carbon nanotube film structure can support itself without a substrate. For example, if at least one point of the carbon nanotube film structure is held, the entire carbon nanotube film structure can be lifted without being damaged. The carbon nanotube film structure can include a number of carbon nanotubes. Adjacent carbon nanotubes in the carbon nanotube film structure can be attached to each other by the van der Waals force therebetween. A number of micropores can be defined in the carbon nanotube film structure. A thickness of the carbon nanotube film structure can range from about 100 nanometers to about 100 micrometers. In some embodiments, the thickness of the carbon nanotube film structure ranges from about 500 nanometers to about 1 micrometer. A diameter of carbon nanotubes can range from about 5 nanometers to about 20 nanometers. In some embodiments, the diameter of the carbon nanotubes ranges from about 10 nanometers to about 15 nanometers. In one embodiment, the diameter of the carbon nanotubes is about 10 nanometers. A length of the carbon nanotubes is not limited. In some embodiments, the length of the carbon nanotubes ranges from about 100 micrometers to about 900 micrometers.

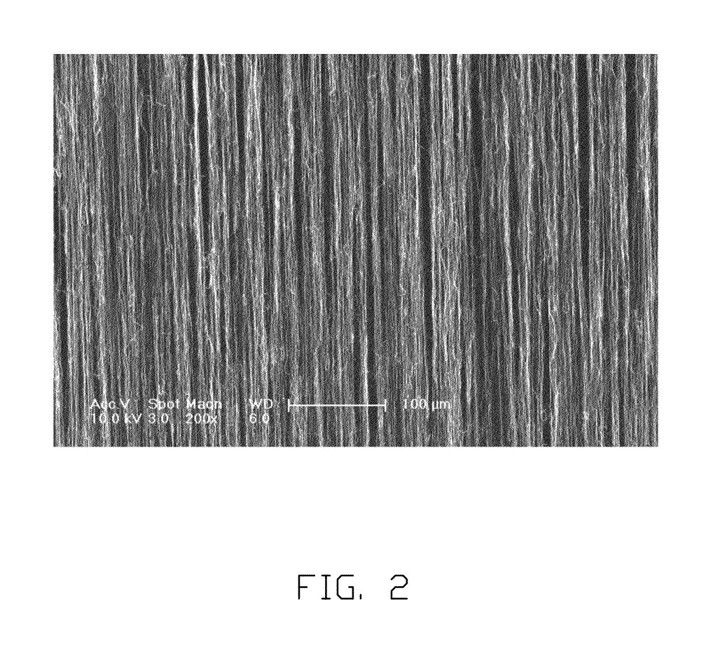

The carbon nanotube film structure can include at least one carbon nanotube film. Referring to FIG. 2, the carbon nanotube film can be a drawn carbon nanotube film formed by drawing a film from a carbon nanotube array. The drawn carbon nanotube film consists of a number of carbon nanotubes. The carbon nanotubes in the drawn carbon nanotube film are arranged substantially parallel to a surface of the drawn carbon nanotube film. A large number of the carbon nanotubes in the drawn carbon nanotube film can be oriented along a preferred orientation, meaning that a large number of the carbon nanotubes in the drawn carbon nanotube film are arranged substantially along a same direction. An end of one carbon nanotube is joined to another end of an adjacent carbon nanotube arranged substantially along the same direction, by van der Waals force, to form a free-standing film. A small number of the carbon nanotubes are randomly arranged in the drawn carbon nanotube film, and have a small if not negligible effect on the larger number of the carbon nanotubes in the drawn carbon nanotube film, that are arranged substantially along the same direction. It can be appreciated that some variation can occur in the orientation of the carbon nanotubes in the drawn carbon nanotube film. Microscopically, the carbon nanotubes oriented substantially along the same direction may not be perfectly aligned in a straight line, and some curved portions may exist. It can be understood that contact between some carbon nanotubes located substantially side by side and oriented along the same direction cannot be totally excluded.

The drawn carbon nanotube film includes a number of successively oriented carbon nanotube segments joined end-to-end by van der Waals force therebetween. Each carbon nanotube segment includes a number of carbon nanotubes substantially parallel to each other and joined by van der Waals force therebetween. The carbon nanotube segments can vary in width, thickness, uniformity, and shape. The carbon nanotubes in the drawn carbon nanotube film are also substantially oriented along a preferred orientation. The width of the drawn carbon nanotube film relates to the carbon nanotube array from which the drawn carbon nanotube film is drawn. Furthermore, the carbon nanotube film has an extremely large specific surface area, and is very sticky.

The carbon nanotube film structure can include more than one stacked drawn carbon nanotube film. An angle can exist between the oriented directions of the carbon nanotubes in adjacent films. Adjacent drawn carbon nanotube films can be combined by the van der Waals force therebetween without the need of an adhesive. An angle between the oriented directions of the carbon nanotubes in two adjacent drawn carbon nanotube films can range from about 0 degrees to about 90 degrees. The number of layers of the drawn carbon nanotube films in the carbon nanotube film structure is not limited. In some embodiments, the carbon nanotube film structure includes about 1 layer to 5 layers of stacked drawn carbon nanotube films. In one embodiment, the carbon nanotube film structure includes 2 layers of stacked drawn carbon nanotube films, and the angle between the oriented directions of the carbon nanotubes of the two drawn carbon nanotube films is about 90 degrees.

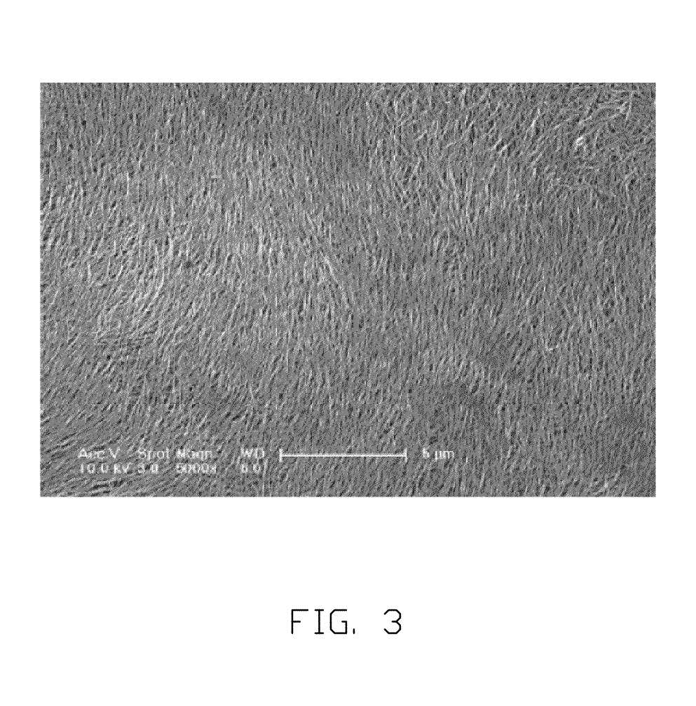

Referring to FIG. 3, the carbon nanotube film can also be a pressed carbon nanotube film formed by pressing a carbon nanotube array down on the substrate. The carbon nanotubes in the pressed carbon nanotube array can be arranged along a same direction or along different directions. The carbon nanotubes in the pressed carbon nanotube array can rest upon each other. Some of the carbon nanotubes in the pressed carbon nanotube film can protrude from a general surface/plane of the pressed carbon nanotube film. Adjacent carbon nanotubes are attracted to each other and combined by van der Waals force. When the carbon nanotubes in the pressed carbon nanotube array are arranged along different directions, the carbon nanotube structure can be isotropic.

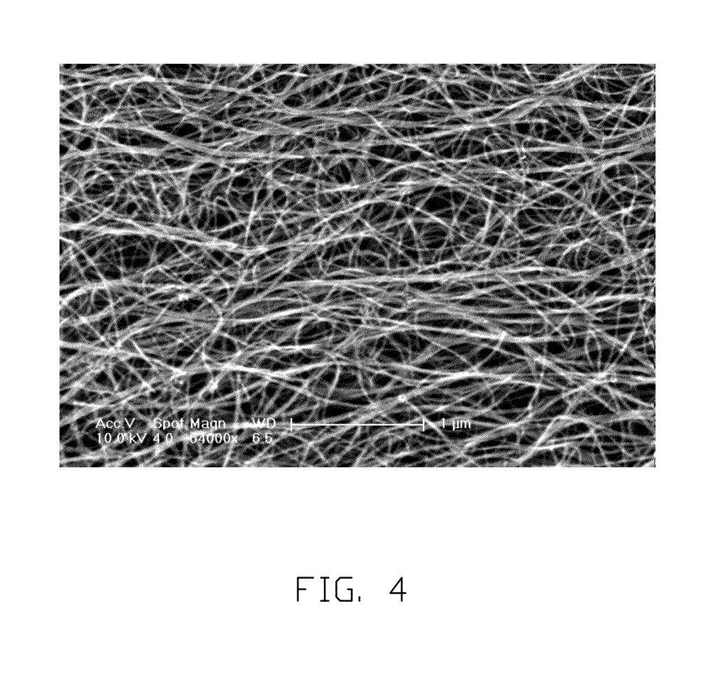

Referring to FIG. 4, the carbon nanotube film can also be a flocculated carbon nanotube film formed by a flocculating method. The flocculated carbon nanotube film can include a number of long, curved, disordered carbon nanotubes entangled with each other. The carbon nanotubes can be substantially uniformly distributed in the carbon nanotube film. The adjacent carbon nanotubes are acted upon by the van der Waals force therebetween. Some of the carbon nanotubes in the flocculated carbon nanotube film can protrude from a general surface/plane of flocculated carbon nanotube film.

In step S11, a method for making the anode active solution includes sub-steps of:

S111, providing a Co(NO₃)₂ solution; and

S112, providing an organic solvent and mixing the organic solvent with the Co(NO₃)₂ solution to achieve the anode active solution.

In step (S111), the Co(NO₃)₂ solution can be obtained by dissolving a number of Co(NO₃)₂ particles in water. A concentration of the Co(NO₃)₂ solution can range from about 0.1 mol/L to about 5 mol/L. In some embodiments, the concentration of the Co(NO₃)₂ solution ranges from about 0.5 mol/L to about 2 mol/L. In one embodiment, the concentration of the Co(NO₃)₂ solution is about 1 mol/L.

In step (S112), the organic solvent can be volatile at room temperature and have good wettability with carbon nanotubes. The organic solvent can be ethanol, methanol, acetone, dichloroethane, isopropyl alcohol, chloroform, or any combinations thereof. In one embodiment, the organic solvent is isopropyl alcohol. A ratio of a volume of the Co(NO₃)₂ solution to a volume of the organic solvent can range from about 1:1 to about 10:1. In some embodiments, the ratio of the volume of the Co(NO₃)₂ solution to the volume of the organic solvent ranges from about 2:1 to about 5:1. In one embodiment, the ratio of the volume of the Co(NO₃)₂ solution to the volume of the organic solvent is about 4:1.

In step (S12), the anode active solution can be sprayed on surfaces of the carbon nanotube film structure by spray method. Because the carbon nanotube film structure has little thickness, such as less than 100 micrometers, the anode active solution can be infiltrated into the inter structure of the carbon nanotube film structure without breaking the entire carbon nanotube film structure. Furthermore, the anode active solution can be uniformly adsorbed on surfaces of the carbon nanotubes because of the good wettability of the organic solvent.

After the pre-anode is obtained, a step of stacking a number of the pre-anodes together can be further executed. Thus, a mechanical strength of the pre-anode can be improved.

The step (S13) can be carried out in an inert gas condition to prevent the carbon nanotube film structure from being oxidized.

During the heat treating process, the water and the organic solvent in the pre-anode can be evaporated from the pre-anode to form a number of Co(NO₃)₂ particles on surfaces of the carbon nanotubes; furthermore, the Co(NO₃)₂ particles formed on surfaces of the carbon nanotubes can be decomposed to form a number of anode active particles, such as Co₃O₄ particles, on surfaces of the carbon nanotubes. A temperature of the heat treating process can be greater than a decomposition temperature of the Co(NO₃)₂ particles. The temperature of the heat treating process can range from about 250° C. to about 350° C. When the temperature of the heat treating process is lower than the decomposition temperature of the Co(NO₃)₂ particles, the Co(NO₃)₂ particles cannot decompose to form the anode active particles. When the temperature of the heat treating process is greater than 350° C., a crystallization of the Co₃O₄ particles can be damaged and the carbon nanotubes can be decomposed by the Co₃O₄ particles. In some embodiments, the temperature of the heat treating process ranges from about 280° C. to about 320° C. In one embodiment, the temperature of the heat treating process is about 300° C.

Furthermore, a step of drying the pre-anode can be carried out before step (S13) and after step (S12). During the drying process, the water and the organic solvent in the pre-anode can be evaporated from the pre-anode, to prevent the organic solvent from reacting with the Co(NO₃)₂ particles. A temperature of the drying process can range from about 50° C. to about 100° C. In one embodiment, the temperature of the Page 10 of 20 drying process is about 80° C.

The method for fabricating the lithium battery anode of the present embodiment has the following advantages. First, the anode active solution can be uniformly adsorbed on surfaces of the carbon nanotubes because of the good wettability of the organic solvent, thus, after the heat treating process, the anode active particles can be firmly adsorbed on surfaces of the carbon nanotubes. As such, a stable lithium battery anode can be obtained. Second, by controlling the temperature of the heat treating process, the Co₃O₄ particles can have good crystallization without damaging the carbon nanotube film structure, thus, a property of the lithium battery anode can be improved.

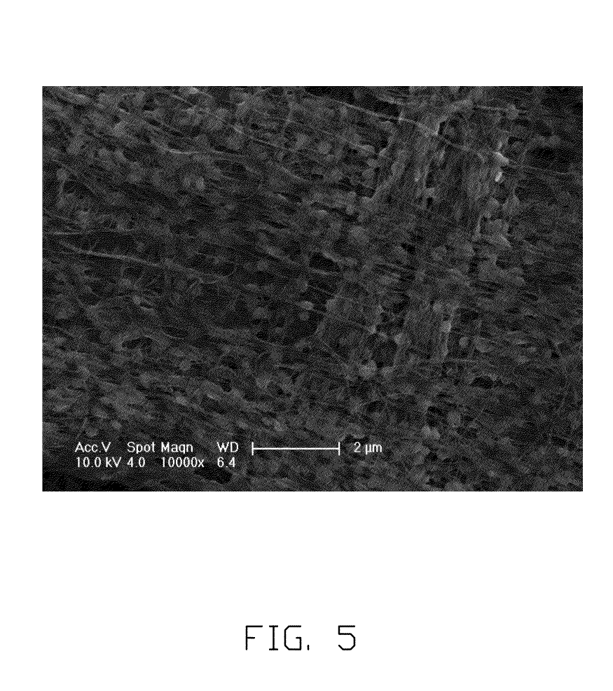

Referring to FIG. 5, a lithium battery anode formed by the above method is provided according to one embodiment. The lithium battery anode includes a carbon nanotube film structure and a number of Co₃O₄ particles located in the carbon nanotube film structure. A diameter of the Co₃O₄ particles ranges from about 50 nanometers to about 10 micrometers. In some embodiment, the diameter of the Co₃O₄ particles ranges from about 100 nanometers to about 500 nanometers. In one embodiment, the diameter of the Co₃O₄ particles is about 250 nanometers. A capacity of the lithium battery anode is about 3 times greater than a capacity of a graphite anode (330 mAh/g).

The lithium battery anode of the present embodiment has the following advantages. First, the anode active material can be uniformly dispersed in the carbon nanotube film structure without aggregation, as such, a stable lithium battery anode with high conductivity can be obtained. Second, during the use of the lithium battery anode, the lithium ion can be inserted into the micropores of the carbon nanotube film structure, thus, a volume of the anode active material can remain unchanged to obtain a more stable lithium battery anode.

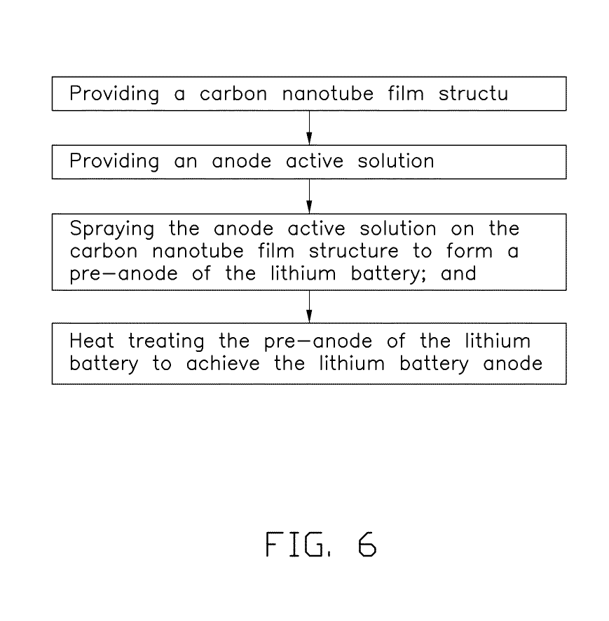

Referring to FIG. 6, a method for fabricating a lithium battery anode of another embodiment includes the steps of: (S20) providing a carbon nanotube film structure; (S21) providing an anode active solution; (S22) spraying the anode active solution on the carbon nanotube film structure to form a pre-anode; and (S23) heat treating the pre-anode.

The step (S20) can be the same as the step (S10).

A method for making the anode active solution of step (S21) includes sub-steps of:

S211, providing a Co(II) solution and an ammonia solution;

S212, adding the ammonia solution into the Co(II) solution to form a suspension solution; and

S213, providing an organic solvent and adding the organic solvent into the suspension solution to achieve the anode active solution.

In step (S211), the Co(II) solution can be CoCl₂ solution, CoSO₄ solution, Co(NO₃)₂ solution, or their combinations. A concentration of the Co(II) solution can range from about 0.1 mol/L to about 5 mol/L. In some embodiments, the concentration of the Co(II) solution ranges from about 0.5 mol/L to about 2 mol/L. In one embodiment, the Co(II) solution is Co(NO₃)₂ solution having a concentration of about 1 mol/L. A concentration of the ammonia solution can range from about 0.1 mol/L to about 5 mol/L. In one embodiment, the concentration of ammonia solution is about 1 mol/L.

In step (S212), when the ammonia solution is added into the Co(II) solution, the Co²⁺ ion of the Co(II) solution can react with the OH⁻ ion of the ammonia solution to form a number of Co(OH)₂ particles. A diameter and an amount of the Co(OH)₂ particles can be controlled by the concentration and an amount of the ammonia solution.

In step (S213), the organic solvent can be volatile at room temperature and have good wettability with carbon nanotubes, such as, ethanol, methanol, acetone, dichloroethane, isopropyl alcohol, chloroform, or any combination thereof. In one embodiment, the organic solvent is isopropyl alcohol. A ratio of a volume of the suspension solution to a volume of the organic solvent can range from about 1:1 to about 10:1. In some embodiments, the ratio of the volume of the suspension solution to the volume of the organic solvent ranges from about 2:1 to about 5:1. In one embodiment, the ratio of the volume of the suspension solution to the volume of the organic solvent is about 4:1.

It is to be understood that, the anode active solution can also be obtained by dispersing a number of Co(OH)₂ particles into the organic solvent directly. A diameter of the Co(OH)₂ particles can range from about 50 nanometers to about 100 micrometers. In some embodiment, the diameter of the Co(OH)₂ particles ranges from about 10 nanometer to about 50 nanometers.

In step (S22), after the anode active solution is sprayed on the carbon nanotube film structure, the Co(OH)₂ particles are uniformly adsorbed on surfaces of the carbon nanotubes because of the good wettability of the organic solvent, thus achieving the pre-anode. Other characteristics of step (S22) are the same as step (S12).

In step (S23), the heat treating process is carried out in air condition. During the heat treating process, the water and the organic solvent in the pre-anode can be evaporated from the pre-anode to form a number of Co(OH)₂ particles on surfaces of the carbon nanotubes; furthermore, the Co(OH)₂ particles formed on surfaces of the carbon nanotubes can be further decomposed and oxidized to form the anode active particles, such as Co₃O₄ particles, on surfaces of the carbon nanotubes. A temperature of the heat treating process can be greater than a decomposition temperature of the Co(OH)₂. The temperature of the heat treating process can range from about 250° C. to about 350° C. When the temperature of the heat treating process is lower than the decomposition temperature of the Co(OH)₂, the Co(OH)₂ fails to decompose and oxidized to form the anode active particles. When the temperature of the heat treating process is greater than 350° C., a crystallization of the Co₃O₄ particles can be damaged and the carbon nanotubes can be decomposed by the Co₃O₄ particles. In some embodiments, the temperature of the heat treating process ranges from about 280° C. to about 320° C. In one embodiment, the temperature of the heat treating process is about 300° C.

A lithium battery anode formed by the above method according to one embodiment is provided. The lithium battery anode includes a carbon nanotube film structure and a number of Co₃O₄ particles located in the carbon nanotube film structure. A diameter of the Co₃O₄ particles ranges from about 50 nanometers to about 100 micrometers. In some embodiment, the diameter of the Co₃O₄ particles ranges from Page 15 of 20 about 1 micrometer to about 10 micrometers. In one embodiment, the diameter of the Co₃O₄ particles is about 2 micrometers. A capacity of the lithium battery anode is about 2-3 times greater than a capacity of the graphite anode.

It is to be understood that the above-described embodiment is intended to illustrate rather than limit the disclosure. Variations may be made to the embodiment without departing from the spirit of the disclosure as claimed. The above-described embodiments are intended to illustrate the scope of the disclosure and not restricted to the scope of the disclosure.

It is also to be understood that the above description and the claims drawn to a method may include some indication in reference to certain steps. However, the indication used is only to be viewed for identification purposes and not as a suggestion as to an order for the steps.

1. A method for fabricating a lithium battery anode, comprising steps of:
(a) providing a carbon nanotube film structure;
(b) forming an anode active solution by sub-steps of;
(b1) providing a Co(NO₃)₂ solution and an organic solvent; and
(b2) mixing the organic solvent with the Co(NO₃)₂ solution to achieve the anode active solution;
(c) applying the anode active solution on the carbon nanotube film structure to form a pre-anode; and
(d) heat treating the pre-anode.

2. The method as claimed in claim 1, wherein a concentration of the Co(NO₃)₂ solution ranges from about 0.1 mol/L to about 5 mol/L.

3. The method as claimed in claim 2, wherein the concentration of the Co(NO₃)₂ solution ranges from about 0.5 mol/L to about 2 mol/L.

4. The method as claimed in claim 1, wherein the organic solvent is volatile at room temperature and has wettability with carbon nanotubes.

5. The method as claimed in claim 1, wherein the organic solvent comprises a material selected from the group consisting of ethanol, methanol, acetone, dichloroethane, isopropyl alcohol, chloroform, and their combination.

6. The method as claimed in claim 1, wherein a ratio of a volume of the Co(NO₃)₂ solution to a volume of the organic solvent ranges from about 1:1 to about 10:1.

7. The method as claimed in claim 6, wherein the ratio of the volume of the Co(NO₃)₂ solution to the volume of the organic solvent ranges from about 2:1 to about 5:1.

8. The method as claimed in claim 6, wherein the ratio of the volume of the Co(NO₃)₂ solution to the volume of the organic solvent is about 4:1.

9. The method as claimed in claim 1, wherein a temperature of the step of heat treating the pre-anode ranges from about 250° C. to about 350° C.

10. The method as claimed in claim 9, wherein the temperature of the step of heat treating the pre-anode ranges from about 280° C. to about 320° C.

11. The method as claimed in claim 9, wherein the temperature of the step of heat treating the pre-anode is about 300° C.

12. The method as claimed in claim 1, wherein a thickness of the carbon nanotube film structure ranges from about 100 nanometers to about 100 micrometers.

13. The method as claimed in claim 12, wherein the thickness of the carbon nanotube film structure ranges from about 500 nanometers to about 1 micrometer.

14. The method as claimed in claim 1, wherein step (d) is carried out in air condition.

15. The method as claimed in claim 1, further comprising a step of drying the pre-anode before the step (d).

16. The method as claimed in claim 15, wherein a temperature of the drying the pre-anode ranges from about 50° C. to about 100° C.

17. The method as claimed in claim 1, further comprising a step of stacking a plurality of the pre-anodes of the lithium battery before the step (d).

18. The method as claimed in claim 1, wherein the carbon nanotube film structure comprises at least one carbon nanotube film.

19. The method as claimed in claim 1, wherein the carbon nanotube film structure comprises 2 layer to 5 layers of stacked drawn carbon nanotube films.
